(19) United States
(12) Patent Application Publication
(10) Pub. No.: US 2026/0307955 A1
(43) Pub. Date: Oct. 8, 2026

(54) FIELD-DEPLOYABLE MODULAR SNATCH BLOCK DEVICE

(71) Applicant: Wayne Weber, Federal Way, WA (US)

(72) Inventor: Wayne Weber, Federal Way, WA (US)

(21) Appl. No.: 19/171,261

(22) Filed: Apr. 5, 2025

(51) Int. Cl. B66D 3/06

(52) U.S. Cl. CPC B66D 3/06

(57) ABSTRACT

A single-piece mechanical advantage device comprising a solid body formed by machining, molding, or casting, with one or more integrally formed passive pulley grooves configured to redirect cordage without rotating components. The device includes through-holes and anchor points for secure attachment to trees, poles, vehicles, or equipment using bolts, carabiners, or lashing. Multiple units may be stacked and lashed together to create compound pulley systems, with optional alignment features or variable groove diameters to reduce friction and cord interference. The body may incorporate drainage channels, surface texture for heat dissipation, and etched or laser-marked instructions for field use. Designed for durability and tool-free deployment, the device supports integration with belts, MOLLE-compatible gear, and other modular equipment systems. Variants may be color-coded and produced in multiple sizes to accommodate a range of load and environmental conditions.

### FIELD

This invention relates to mechanical advantage devices and pulley systems, specifically to a compact, stackable, and field-deployable snatch block intended for use in outdoor, tactical, or utility environments.

### BACKGROUND

Traditional snatch blocks and pulley systems often rely on multiple components, including rotating sheaves, side plates, and fasteners. While effective for redirecting force and gaining mechanical advantage, these assemblies tend to be heavy, bulky, prone to mechanical failure, and inconvenient for field use where weight, simplicity, and durability are critical.

Many existing systems are difficult to rig without tools, require precise alignment, or cannot be easily stacked or adapted for modular configurations. Furthermore, their reliance on moving parts increases the likelihood of malfunction in harsh environments such as sand, mud, or freezing conditions.

There is a need for a mechanical advantage device that is lightweight, compact, and highly durable, while eliminating the complexity and failure points associated with traditional pulley systems. A solution that allows for tool-free rigging, modular stacking, and seamless integration with personal gear such as belts or field equipment would address a significant gap in both recreational and tactical applications.

### BRIEF SUMMARY

The present invention provides a compact, single-piece mechanical advantage device designed for field use. The device may be machined, molded, or cast from various materials and includes one or more passive pulley grooves formed integrally into its structure, allowing cordage to be routed through, for force redirection without the use of rotating elements or moving parts.

The device features multiple apertures and anchor points enabling it to be secured via lashing, bolts, carabiners, or straps to a wide variety of field anchors, such as trees, poles, or equipment. Its shape and structure allow for stacking with identical units using cordage, enabling users to build modular compound pulley systems for increased mechanical advantage.

In addition to its mechanical function, the device is designed for portability and integration with field gear, including mounting on belts, backpacks, or webbing systems for easy carry and rapid deployment. Multiple size variants and optional color-coding provide clear identification and load-specific functionality.

### BRIEF DESCRIPTION OF THE DRAWINGS

FIG. 1A & FIG. 1B are a front and side profile view of the device (100), showing a single-piece body with multiple passive pulley grooves (102), through-hole anchor points (103), retention notch (109), optional laser-etched instructions (111), and drainage channels (114).

FIG. 2 is an isometric view highlighting radiused or reinforced through-holes (104), secondary passive pulley groove paths, and the routing of cordage (110) through the system onto a tree branch.

FIG. 3 illustrates a pair of devices stacked using cordage, showing modular stackability (105) and alignment markings or contours (106) for positioning.

FIG. 4 is a front view of the device (100) rotated 90 degrees showing the device configured as a wearable unit, mounted on a belt (108) with cord.

FIG. 5 illustrates a field-deployable pulley system configuration (113), showing cordage routing through stacked devices with varying groove diameters. The figure demonstrates how differential sizing enables rope path separation and reduces friction or interference during rigging in outdoor environments.

FIG. 6 is a detailed section view of a pulley groove containing a bearing or rolling element (112), demonstrating differing pulley diameters (116) to enable cord separation.

FIG. 7 illustrates an alternate embodiment of the device with more than two grooves (115) arranged in plurality to accommodate multi-line rigging or distributed load paths.

FIG. 8 demonstrates with an exploded view an accessory compatible mounting feature example (107).

### Ref. No. Descriptions

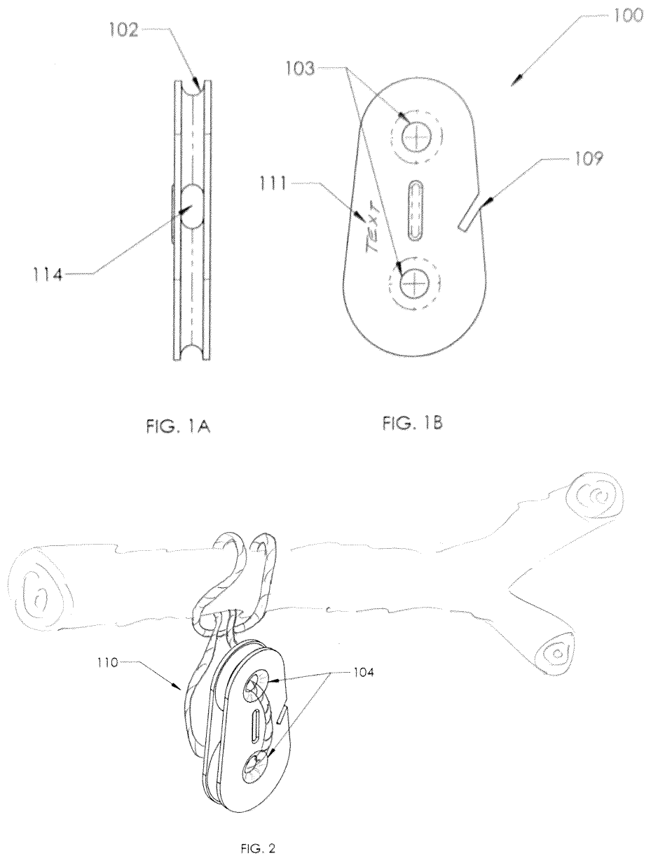

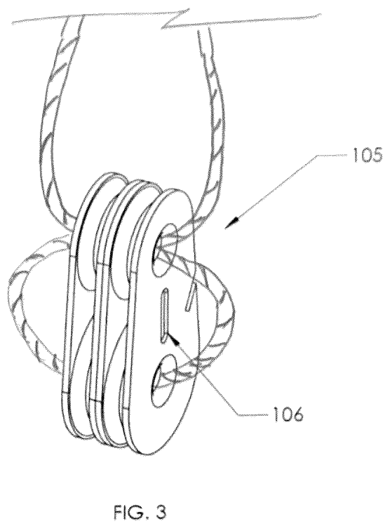

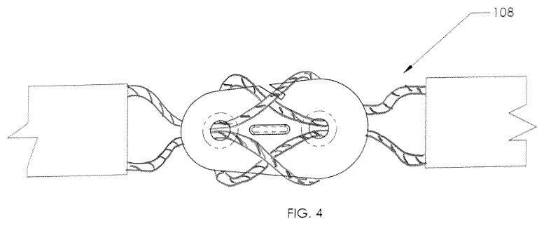

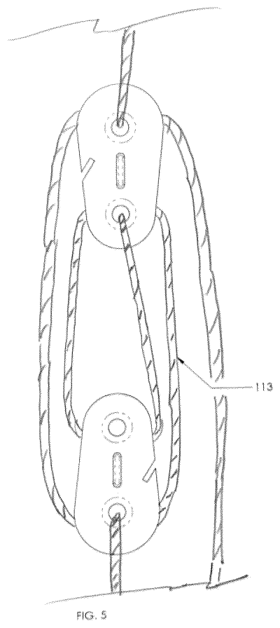

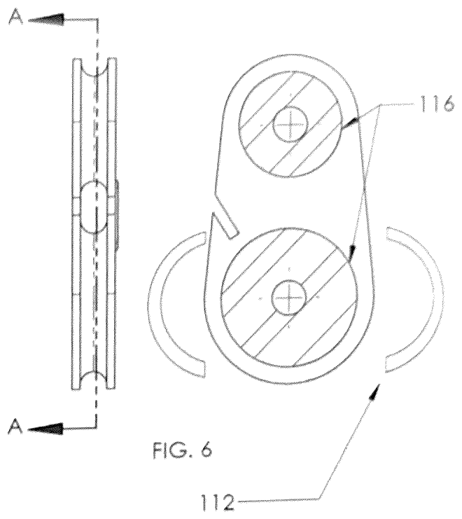

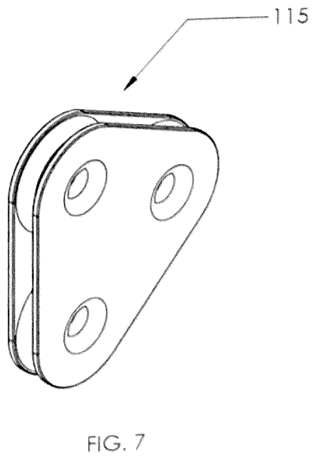

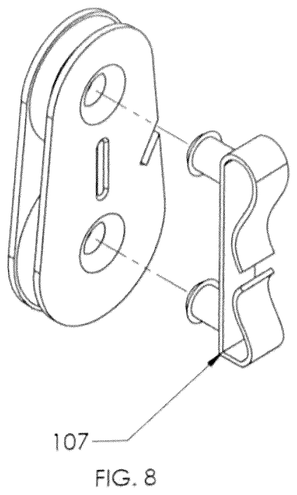

100—Main device body (FIG. 1B)
102—Passive Pulley Groove (FIG. 1A)
103—Anchor hole or through-hole (FIG. 1B)
104—Radiused edge (FIG. 2)
105—Modular stack isometric (FIG. 3)
106—Stack alignment marking feature (FIG. 3)
107—MOLLE compatible mount feature accessory example (FIG. 8)
108—Belt attachment features (FIG. 4)
109—Cord-retaining notch (FIG. 1B)
110—Cordage routing (FIG. 2)
111—Etched/engraved instructional text (FIG. 1B)
112—Bearing or friction liner (FIG. 6)
113—4:1 pulley system (FIG. 5)
114—Drainage feature (FIG. 1A)
115—Tri-passive pully isometric (FIG. 7)
116—Diameter variance section view (FIG. 6)

### DETAILED DESCRIPTION

The present invention is a compact, field-deployable mechanical advantage device (100) illustrated in FIG. 1B. comprising a single-piece body formed by machining, molding, or casting from materials such as aluminum, titanium, high-strength composite, or synthetic materials. In various embodiments, the body may be produced using subtractive or additive manufacturing methods, including CNC machining, injection molding, casting, or other suitable processes depending on the material used. In one embodiment, the device includes multiple grooves (102) spaced along the body, allowing a single unit to route several lines or create compound force paths as shown in FIG. 1A. The grooves (102) are dimensioned to accommodate cordage ranging from approximately 1 mm to 7 mm in diameter and may be smooth or surface-treated (e.g., anodized, coated) to minimize friction and wear. In other embodiments there are greater than two grooves (115) in plurality as shown in FIG. 7.

The body also includes through-holes or slots that serve as anchor points (103) visualized in FIG. 1B. These apertures are positioned to accept carabiners, webbing, cordage, or fasteners such as bolts or screws, allowing secure attachment to anchor objects such as trees, poles, vehicle chassis, or static infrastructure. In some embodiments, these holes are reinforced or radiused (104) represented by FIG. 2 to improve mechanical load-bearing and usability, and may also serve as secondary passive pulley paths.

A key aspect of the invention is its modular stackability (105) presented in FIG. 3. Multiple identical units may be aligned and secured together using lashing cord, cable ties, or other field-available materials. When stacked, the units function as a compound pulley system, increasing mechanical advantage with each additional block. Some embodiments may include interlocking contours or visual alignment markings to aid stacking (106) visually described in FIG. 3.

The device is designed with portability in mind, including versions that integrate or interface with personal gear such as belts (108) seen in FIG. 4, pouches, or MOLLE-compatible equipment (107) depicted in FIG. 8. In one variation, the body includes slots or edge notches that accept a clip, strap, or accessory frame, allowing the device to double as a wearable utility item (e.g., belt buckle (108) depicted in FIG. 4 or external gear attachment. This enables the user to carry the device on-body and deploy it rapidly without digging through a pack.

The invention is suitable for a range of field environments, including wilderness, marine, arctic, and urban settings. Its monolithic, corrosion-resistant structure allows operation in mud, sand, rain, and sub-zero temperatures with no mechanical degradation. Drainage channels or open geometry (114) may facilitate better water and debris shedding as shown in FIG. 1A.

All configurations are designed for tool-free rigging in remote conditions and may be deployed using only cordage (110) represented in FIG. 2 and common field equipment. In some embodiments, the device may also include notches or integrated features (109) presented in FIG. 1. that retain cordage temporarily under tension without requiring external locks or hardware.

In certain embodiments, one or more passive pulley grooves may include low-friction liners (112), rolling elements, or bearings to further reduce drag. These are shown in FIG. 6 and these may be press-fit, snap-in, or integrated during molding. Such configurations preserve modular stackability, lashing capability, and offset groove alignment. Devices with integrated bearings may be used in higher-load or continuous-use scenarios where efficiency is prioritized over mechanical simplicity. In some cases, only select grooves may contain bearings, while others remain friction-based to allow differential movement or line control.

In some embodiments, the device includes etched, engraved, or laser-marked indicia located on one or more exterior surfaces of the body (111) as shown as TEXT in FIG. 1B. These markings may include setup instructions, safety warnings, load direction arrows, or cordage routing guides to assist the user during field deployment. The indicia may be applied during or after manufacture and are designed to be permanent and weather-resistant, allowing legibility in harsh environments such as wet, dusty, or low-light conditions. Such markings improve ease of use and safety, particularly in high-stress or time-sensitive scenarios where rapid deployment is critical. As illustrated in FIG. 1, the top face of the device may include laser-engraved setup icons (111) indicating optimal anchor points and cordage direction.

In certain embodiments, the device includes multiple passive pulley grooves with varying diameters (116) shown in FIG. 6, either within a single body or across stacked units. For example, one device may be positioned below a second device with the smaller diameter grooves towards each other. This configuration allows for synchronized cordage movement while reducing the risk of cordage interference, friction, or misalignment when multiple devices are used together. The differential groove sizing enables the creation of mechanical advantage systems such as a 4:1 compound pulley (113) configuration represented in FIG. 5. The diameter difference also helps maintain separation between rope paths, improving efficiency and safety during use in field conditions. This variation is particularly advantageous for rigging applications requiring multiple lines or directional changes under tension.

1. claim 1, A snatch block device comprising a single-piece body formed by machining, molding, or casting from aluminum, titanium, composite, or synthetic material; at least one passive pulley groove formed integrally within an exterior portion of the body, configured to guide a cord or rope; at least one aperture within the body configured to receive a lashing line, fastener, or carabiner for securing the device to an anchor; wherein the device is adapted to be stacked with one or more similar devices to increase mechanical advantage.

2. The device of claim 1, wherein the body includes a plurality of passive pulley grooves configured for multi-line or compound force routing.

3. The device of claim 1, wherein the single-piece body is formed by machining, molding, or casting from aluminum, titanium, composite, or synthetic material.

4. The device of claim 1, wherein the aperture is dimensioned to receive a bolt or screw for mounting the device to equipment or a structure.

5. The device of claim 1, wherein the aperture or through-holes includes radiused or reinforced edges and may function as an additional passive pulley path.

6. The device of claim 1, wherein the body comprises structural features that enable interlocking or alignment when stacked with additional snatch block devices.

7. The device of claim 1, wherein the body is configured to be stacked with at least one identical device using lashing cord, equivalent flexible restraint, or mechanical hardware.

8. The device of claim 1, wherein the pulley grooves are configured to accommodate cordage ranging from 1 mm to 7 mm in diameter.

9. The device of claim 1, wherein the body includes smooth surface finish, surface treatment, or coating to reduce friction and resist wear.

10. The device of claim 1, wherein the body includes edge notches or interface points to accept a belt clip, MOLLE strap, or accessory mount.

11. The device of claim 1, wherein the body is carried as part of a wearable assembly such as a belt buckle or external utility gear.

12. The device of claim 1, wherein the device is configured for tool-free use in field environments and may be deployed without additional hardware.

13. The device of claim 1, wherein at least one aperture includes a cord-retaining notch or detent to hold tensioned rope temporarily.

14. The device of claim 1, wherein the body is produced in multiple size variants for use with varying cordage diameters or load conditions.

15. The device of claim 14, wherein each size variant includes a distinct color or surface marking for visual identification.

16. The device of claim 1, wherein the body includes integrated visual markings or etched instructions for field setup, safety, and cord routing.

17. The device of claim 1, wherein the body is corrosion-resistant and operable in marine, desert, or arctic environments.

18. The device of claim 1, wherein at least one passive pulley groove has a diameter that differs from another groove on the same or connected device, thereby minimizing cordage interference or friction when multiple units are used together.

19. The device of claim 2, wherein at least one passive pulley groove includes an integrated bearing, rotating element, or low friction liner to reduce friction underload.

20. The device of claim 1, wherein the body includes one or more heat dissipation features comprising fins, surface texture, or thermally conductive materials, configured to increase surface area and enhance thermal regulation during use.
